(19) United States
(12) Patent Application Publication
(10) Pub. No.: US 2014/0333750 A1
(43) Pub. Date: Nov. 13, 2014

(54) HIGH RESOLUTION DUAL-OBJECTIVE MICROSCOPY

(71) Applicant: President and Fellows of Harvard College, Cambridge, MA (US)

(72) Inventors: Xiaowei Zhuang, Lexington, MA (US); Hazen P. Babcock, Lexington, MA (US); Ke Xu, Somerville, MA (US)

(21) Appl. No.: 14/364,723

(22) PCT Filed: Dec. 12, 2012
(86) PCT No.: PCT/US12/09138

§ 371 Date: Jun. 12, 2014

Related U.S. Application Data
(60) Provisional application No. 61/576,089, filed on Dec. 15, 2011.

(51) Int. Cl. G02B 21/36; G02B 27/58; G02B 21/16

(52) U.S. Cl. CPC G02B 21/367; G02B 21/16; G02B 27/58; G02B 2207/113
USPC 348/79

(57) ABSTRACT

The present invention generally relates to super-resolution microscopy. For example, certain aspects of the invention are generally directed to a microscopy system comprising at least two objectives. In some embodiments, the microscopy system may also contain a non-circularly-symmetric lens. One or more images can be obtained using the objectives, for example, using stochastic imaging techniques such as STORM (stochastic optical reconstruction microscopy), optionally in conjunction with entities that are photoactivatable and/or photo switchable. The images obtained using the objectives may be compared, e.g., to remove noise, and/or to compare an entity present in both images, for instance, to determine the z-position of the entity. In some cases, surprisingly high resolutions may be obtained using such techniques, for example, resolutions of better than about 10 nm.

### RELATED APPLICATIONS

This application claims the benefit of U.S. Provisional Patent Application Ser. No. 61/576,089, filed Dec. 15, 2011, entitled “High Resolution Dual-Objective Microscopy,” by Zhuang, et al., incorporated herein by reference in its entirety.

### GOVERNMENT FUNDING

Research leading to various aspects of the present invention was sponsored, at least in part, by the National Institutes of Health under Grant Nos. GM068518 and GM086214. The U.S. Government has certain rights in the invention.

### FIELD OF INVENTION

The present invention generally relates to microscopy and, in particular, to super-resolution microscopy.

### BACKGROUND

Super-resolution microscopy, in general, is defined as optical microscopy at resolutions that exceed the resolution limit set by the diffraction limit of light. Recent advances in super-resolution microscopy include stochastic optical reconstruction microscopy (STORM), near-field scanning optical microscopy (NSOM), stimulated emission depletion (STED), ground state depletion microscopy (GSD), reversible saturable optical linear fluorescence transition (RESOLFT), saturated structured-illumination microscopy (SSIM), and photoactivated localization microscopy (PALM). However, these techniques have certain limits on resolution, and consequently, structures below a certain size, such as certain types of biological structures, cannot be directly imaged using these optical microscopy techniques. Consequently, new optical microscopy techniques with improved resolutions are desirable.

### SUMMARY

The present invention generally relates to super-resolution microscopy. The subject matter of the present invention involves, in some cases, interrelated products, alternative solutions to a particular problem, and/or a plurality of different uses of one or more systems and/or articles.

In one aspect, the present invention is generally directed to a microscopy system. In one set of embodiments, the microscopy system comprises a sample region, a first objective on a first side of the sample region, a second objective on a second side of the sample region, and a non-circularly-symmetric lens positioned in a first imaging path in optical communication with the first objective.

In another set of embodiments, the microscopy system comprises a substantially vertically-positioned sample region, a first objective on a first side of the sample region, and a second objective on a second side of the sample region.

The microscopy system, in accordance with still another set of embodiments, includes a sample region, a first objective on a first side of the sample region, a second objective on a second side of the sample region, and means for acquiring a super-resolution image of a sample in the sample region.

The present invention is generally directed to a method, in another aspect. According to one set of embodiments, the method includes acts of acquiring a first plurality of images from a first side of a sample, acquiring a second plurality of images from a second side of the sample, and comparing the first and second plurality of images to determine positions of one or more entities in the sample by determining the shapes and/or intensities of the appearance of the entities present in the first and second plurality of images

In another set of embodiments, the method includes acts of acquiring a first plurality of images from a first side of a sample, acquiring a second plurality of images from a second side of the sample, and comparing the first and second plurality of images to determine positions of one or more entities in the sample to a resolution of less than about 1000 nm without using interference between light that forms the first plurality of images and light that forms the second plurality of images.

The method, in still another set of embodiments, includes acts of acquiring a first plurality of images from a first side of a sample, acquiring a second plurality of images from a second side of the sample, and comparing the first and second plurality of images to determine positions of one or more emissive entities in the sample, to a resolution of less than the wavelengths of the light emitted by the emissive entities, without using interference between light that forms the first plurality of images and light that forms the second plurality of images.

According to yet another set of embodiments, the method includes acts of acquiring a first plurality of images from a first side of a sample by imaging the sample through a non-circularly-symmetric lens, and acquiring a second plurality of images from a second side of the sample.

In one set of embodiments, the method includes acts of providing a sample comprising photoswitchable fluorescent entities, activating a subset of the photoswitchable fluorescent entities, acquiring a first plurality of images from a first side of the sample, and acquiring a second plurality of images from a second side of the sample.

In another set of embodiments, the method includes acts of providing a sample comprising photoswitchable fluorescent entities, acquiring a first plurality of images from a first side of the sample using a stochastic imaging technique, and acquiring a second plurality of images from a second side of the sample using the stochastic imaging technique.

The method, in still another set of embodiments, includes acts of providing a sample comprising photoswitchable fluorescent entities, acquiring a first plurality of images from a first side of the sample, acquiring a second plurality of images from a second side of the sample, and determining x, y, and z positions of at least one of the photoswitchable fluorescent entities in the sample, using the first and second plurality of images, to a resolution of less than about 1000 nm. In another set of embodiments, the method includes acts of providing a sample comprising photoswitchable fluorescent entities, acquiring a first plurality of images from a first side of the sample, acquiring a second plurality of images from a second side of the sample, and determining x, y, and z positions of at least one of the photoswitchable fluorescent entities in the sample, using the first and second plurality of images, to a resolution of less than a wavelength of light emitted by the photoswitchable fluorescent entity.

According to yet another set of embodiments, the method includes acts of providing a sample comprising one or more entities, acquiring a first plurality of images from a first side of the sample, acquiring a second plurality of images from a second side of the sample, accepting entities due to anticorrelated changes between the appearance of the entities in the first plurality of images and the appearance of the entities in the second plurality of images, and assembling the accepted entities into a final data set or image. The method, in still another set of embodiments, includes acts of providing a sample comprising one or more entities, acquiring a first plurality of images from a first side of the sample, acquiring a second plurality of images from a second side of the sample, rejecting entities due to correlated changes between the appearance of the entity in the first plurality of images and the appearance of the entity in the second plurality of images, and assembling the first and second plurality of images into a final data set or image while suppressing the rejected entities.

In another aspect, the present invention encompasses methods of making one or more of the embodiments described herein. In still another aspect, the present invention encompasses methods of using one or more of the embodiments described herein.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIGS. 1A-1B illustrate various configurations of microscopy systems in accordance with certain embodiments of the invention;

FIGS. 1C-1E illustrate super-resolution imaging, in certain embodiments of the invention;

FIGS. 2A-2F illustrate super-resolution imaging of individual actin filaments in cells, in certain embodiments of the invention; and

FIGS. 3A-3M illustrate super-resolution imaging of actin networks in cells, in accordance with some embodiments of the invention.

### DETAILED DESCRIPTION

The present invention generally relates to super-resolution microscopy. For example, certain aspects of the invention are generally directed to a microscopy system comprising at least two objectives. In some embodiments, the microscopy system may also contain a non-circularly-symmetric lens. One or more images can be obtained using the objectives, for example, using stochastic imaging techniques such as STORM (stochastic optical reconstruction microscopy), optionally in conjunction with entities that are photoactivatable and/or photoswitchable. The images obtained using the objectives may be compared, e.g., to remove noise, and/or to compare an entity present in both images, for instance, to determine the z-position of the entity. In some cases, surprisingly high resolutions may be obtained using such techniques, for example, resolutions of better (or less) than about 10 nm in terms of full width at half maximum.

In some aspects, the present invention is generally directed to microscopy systems, especially optical microscopy systems, for acquiring images at super-resolutions, or resolutions that are smaller than the theoretical Abbe diffraction limit of light. In certain embodiments of the invention, as discussed below, surprisingly high (small) resolutions may be obtained using such techniques, for example, resolutions of less than about 20 nm, less than about 15 nm, or less than about 10 nm.

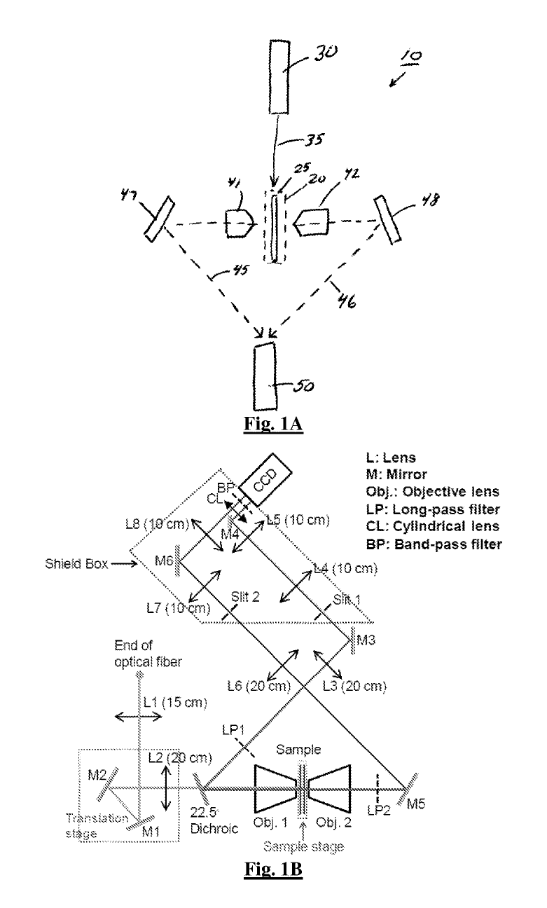

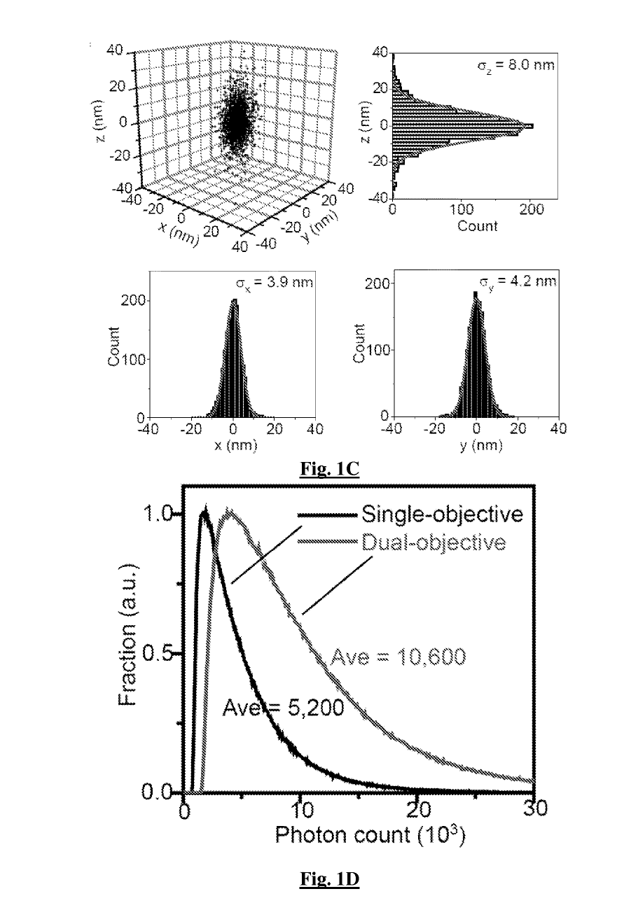

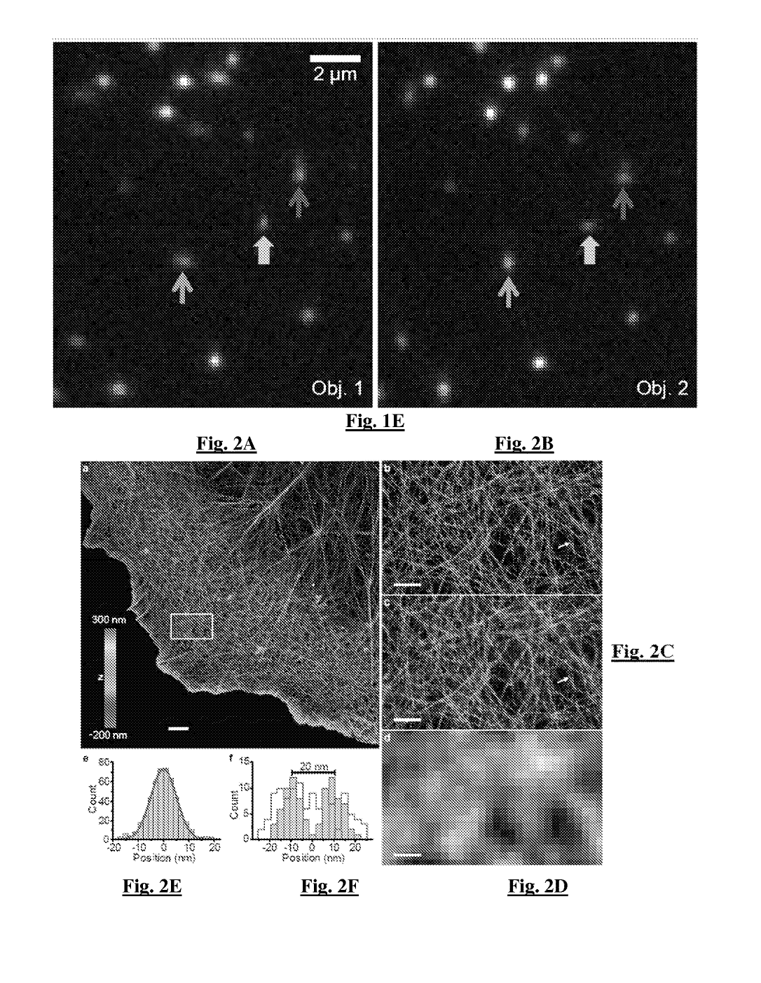

One example of an embodiment of the invention is now described with respect to FIG. 1. As will be discussed in more detail below, in other embodiments, other configurations may be used as well. FIG. 1A illustrates microscopy system 10 comprising sample region 20 containing sample 25, illumination source 30, and detector 50. On either side of sample 25 are objectives 41 and 42. Light 35 from illumination source 30 may be directed to sample region 20 to illuminate sample 25. For instance, light from the illumination source may be directed through one or more of the objectives, or as is shown in FIG. 1A, light 35 may be used to illuminate sample region 20 without being passed through objectives 41 or 42. In some cases, the light from the illumination source may interact with various optical components, such as lenses, mirrors (e.g., dichroic mirrors or polychroic mirrors), beam splitters, filters, slits, windows, prisms, diffraction gratings, optical fibers, etc., before illuminating the sample. In some cases, more than one illumination source can be used. In some cases, the light from the sample being collected on the first side using the first objective and the light from the sample being collected on the second side using the second objective may be directed onto two separate detectors, instead of the single detector 50 as shown in FIG. 1A.

One or more images may be acquired using one or more detectors and/or one or more objectives. For example, as is shown in FIG. 1A, imaging paths 45 and 46 from sample 25 respectively pass through objectives 41 and 42 before reaching detector 50. In this figure, mirrors 47, 48 are used to direct each of the imaging paths to detector 50. However, in other examples, a variety of optical components may be used to direct the imaging paths to a detector (or to different detectors), for example, lenses, mirrors, beam splitters, filters, slits, windows, prisms, diffraction gratings, optical fibers, etc.

In one set of embodiments, super-resolution techniques may be used to obtain one or more images from sample 25, via one or both of objectives 41 and 42. For example, a stochastic imaging technique such as STORM (“Stochastic Optical Reconstruction Microscopy”) or 3D-STORM may be used. See, e.g., International Patent Application No. PCT/US2008/013915, filed Dec. 19, 2008, entitled “Sub-diffraction Limit Image Resolution in Three Dimensions,” by Zhuang, et al., published as WO 2009/085218 on Jul. 9, 2009; and U.S. Pat. No. 7,838,302, issued Nov. 23, 2010, entitled “Sub-Diffraction Limit Image Resolution and Other Imaging Techniques,” by Zhuang, et al., each incorporated herein by reference. In some stochastic imaging techniques, incident light is applied to a sample to cause a statistical subset of entities present within the sample to emit light, the emitted light is acquired or imaged, and the entities are deactivated (either spontaneously, or by causing the deactivation, for instance, with suitable deactivation light). This process may be repeated any number of times, each time causing a statistically different subset of the entities to emit light, and this process may be repeated to produce a final, stochastically produced image.

If two or more objectives are used, as is shown in FIG. 1A, then one or more images may be obtained with each of the objectives. In some cases, the images obtained using the objectives are compared to determine correlations between the images. For example, the same emissive entity may be observed in a first image obtained using a first objective and a second image using a second objective. In certain embodiments, the shape and/or intensity of the entity can be compared, for example, to determine the location of the entity, and/or to determine whether to accept or reject the entity.

In one set of embodiments, the shape and/or intensity of the entity in the first and second images are compared to determine the position of the entity within the sample region, for example, if a non-circularly-symmetric lens is used. In some embodiments, using certain types of non-circularly-symmetric lenses, the shape and/or intensity of an entity (i.e., of the appearance of the entity in an image) may be distorted to different degrees based in part on the distance between the entity and the focal plane of the objective (i.e., in the z direction). Accordingly, by observing the amount of distortion present in the first and/or second images, the position of the entity within the sample region may be determined. Using two objectives, in some cases, can result in significantly higher resolution of the entity in the z direction, than using just a single objective.

In certain embodiments, a property of the entity in a first image detected using the first objective and in a second image detected using the second objective can be compared to determine if that property appears to be correlated or anticorrelated, and the entity may be accepted or rejected based on the anticorrelated or correlated appearance of the entity in the images. For example, the property may be the shape and/or intensity of the entity in the first image and in the second image. Thus, for instance, an anticorrelated entity can appear to be distorted in a first direction in the first image and distorted in a second direction in the second image, where the second direction is in a different direction than the first direction; an entity that is not anticorrelated may be an entity in the first and second images that has distortions in each image in substantially the same direction, or the entity may appear to be undistorted in one or both images, etc. Thus, for example, anticorrelated entities may be accepted as “true” entities present within the sample region, while entities that do not show such an anticorrelated appearance may be rejected as being noise or abnormalities.

While others have used super-resolution microscopy and dual-objective imaging to determine the positions of entities in the z direction in a sample region, those techniques typically rely on interferometry rather than comparing the image shape and/or intensity of the entities detected from the two objectives to obtain information about the position of the entity in the z direction. Such techniques are cumbersome and require optical components and configurations necessary to cause a photon to form its own coherent reference beam in order to interfere with itself to produce a signal that can be analyzed via interferometry, such that information about the z direction can be obtained. For example, in order to cause a photon to form its own coherent reference beam in order to interfere with itself, one or more beam splitters must be used, and/or the optics must be sufficiently precisely aligned so that light from the sample region obtained from the two objectives interferes or otherwise superposes with itself. Accordingly, very precise alignments are needed. However, as discussed herein, in various embodiments of the present invention, interference between light collected using various objectives is unnecessary to determine the positions of entities in the z direction; instead, information about the z direction is determined directly from the images of the entities obtained from the two objectives, for example, by comparing shape and/or intensity information of the images detected using the two objectives.

As mentioned, certain aspects of the present invention are directed to microscopy systems, especially optical microscopy systems, able to produce super-resolution images (or data sets). In some cases, the microscopy system comprises a plurality of objectives, e.g., positioned on various sides of the sample region, and a non-circularly-symmetric lens positioned in at least a first imaging path in optical communication with at least one of the objectives. Such microscopy systems may be used to study any of a variety of suitable samples. The samples can be biological and/or non-biological in origin. For example, the sample studied may be a non-biological sample (or a portion thereof) such as a microchip, a MEMS device, a nanostructured material, or the sample may be a biological sample such as a cell, a tissue, a virus, or the like (or a portion thereof).

The microscopy system may comprise a sample region for holding and/or containing a sample. In some cases, the sample region is substantially planar, although in other cases, a sample region may have other shapes. In certain embodiments, the sample region (or the sample contained therein) has an average thickness of less than about 1 mm, less than about 300 micrometers, less than about 100 micrometers, less than about 30 micrometers, less than about 10 micrometers, less than about 3 micrometers, less than about 1 micrometer, less than about 750 nm, less than about 500 nm, less than about 300 nm, or less than about 150 nm.

In some cases, as is discussed below, the sample region is substantially vertically positioned. Typically, one or more objectives can be positioned relative to the sample region such that a focal plane of an objective is also substantially vertically positioned. When a sample is positioned vertically in the sample region, the force of gravity on the sample can cause entities in the sample to move or settle in the same focal plane. Accordingly, entities moving under the effects of gravity will continue to stay in focus in images obtained using the objective, unlike more traditionally horizontally-positioned sample regions, where even slight changes in the positions of the entities under the effects of gravity could potentially cause the entities to move into or out of the focal plane of the objective, accordingly making it harder to determine the position of the entities. In certain cases, for instance, the correction of movement or drift of entities within the focal plane of the objective (i.e., in the x-y directions) is more precise than in the z direction substantially normal to the focal plane of the objective. Accordingly, a vertically-positioned sample region allows entities to be more precisely studied, as movement of the entities due to gravity does not cause the entities to move out of the focal plane of the objective. However, it should be understood that vertical positioning of a sample region is not a requirement of the present invention, and in other embodiments, the sample region may be substantially horizontally positioned instead.

In certain embodiments, immersion objectives are used, for instance, oil immersion lenses, water immersion lenses, solid immersion lenses, etc. (although in other embodiments, other, non-immersion objectives can be used). In certain embodiments, objectives are positioned on various sides of a sample. If immersion objectives are used, it may be more difficult to position the sample such that forces exerted by the immersion fluid on the sample (e.g., due to surface tension, capillary action, etc.) are able to substantially balance each other in a horizontally-positioned sample (for example, due to differing gravitational effects on the movement of fluids and/or the sample). However, if the sample is positioned substantially vertically, the forces created by the immersion fluids on either side of the sample may be substantially equal (since gravity would not play a major role in these forces), e.g., if the fluid compositions and/or amounts are the same. Accordingly, there would be less of a tendency for the sample to move in a particular direction within the sample region, thereby improving precision or resolution of the images of the sample.

Any of a variety of techniques can be used to position a sample within the sample region (which may be substantially horizontally positioned, substantially vertically positioned, or positioned at any other suitable angle). For example, the sample may be positioned in the sample region using clips, clamps, or the like. In some cases, the sample can be held or manipulated using various actuators or controllers, such as piezoelectric actuators. Suitable actuators having nanometer precision can be readily obtained commercially. For example, in certain embodiments, the sample may be positioned relative to a translation stage able to manipulate at least a portion of the sample region, and the translation stage may be controlled at nanometer precision, e.g., using piezoelectric control.

As previously discussed, two or more objectives may be used, in accordance with various embodiments of the invention. The objectives may each be any suitable objective, and may each be air or immersion objectives. The objectives may each independently be the same or different. The objectives can have any suitable magnification and any suitable numerical aperture, although higher magnification objectives are typically preferred. For example, the objectives may each be about 4×, about 10×, about 20×, about 32×, about 50×, about 64×, about 100×, about 120×, etc., while in some cases, the objective may have a magnification of at least about 50×, at least about 80×, or at least about 100×, The numerical aperture can be, for instance, about 0.2, about 0.4, about 0.6, about 0.8, about 1.0, about 1.2, about 1.4, etc. In certain embodiments, the numerical aperture is at least 1.0, at least 1.2, or at least 1.4. Many types of microscope objectives are widely commercially available.

Any number of objectives may be used in different embodiments of the invention, and the objectives may each independently be the same or different, depending on the application. In one set of embodiments, for instance, two objectives are used, positioned on either side of a sample region. The objectives can be positioned such that each objective is used to image the same location of the sample region (or at least, such that the regions imaged by each of the objectives overlaps). Such a configuration is also referred to as a “dual-objective” system. For instance, the objectives may be positioned at about 180° relative to each other, or at any other suitable angles such that each objective can focus on the same location within the sample region. The objectives can also be positioned in some embodiments such that focal planes for each objective overlap, and/or such that the objectives are collinearly positioned relative to each other.

However, in other embodiments, other numbers of objectives may be used. For example, a microscopy system may have three, four, five, six, etc. objectives that can be used to image a sample in the sample region. For example, a microscopy system may have at least three, four, five, six, etc. objectives each focused on a single position within the sample region (e.g., such that the regions imaged by each of the objectives overlaps), or positioned such that there are multiple focal positions within the sample region for various objectives. As a non-limiting example, a microscopy system may have four objectives and two focal positions, each of which is focused on by two objectives.

As will be discussed in more detail below, in certain embodiments, microscopy systems such as those discussed herein may be used for locating the z position of entities within a sample region. The z position is typically defined to be in a direction defined by an objective (e.g., towards or away from the objective). In some cases, the z position can also be orthogonal to the focal (x-y) plane of the objective. The sample is usually substantially positioned within the focal plane of the objective, and thus, the z direction may also be taken in some embodiments to be in a direction substantially normal to the sample or the sample region (or at least a plane defined by the sample, e.g., if the sample itself is not substantially flat), e.g., in embodiments where the sample and/or the sample region is substantially planar.

In one set of embodiments, the z position of an entity within a sample region is determined in microscopy systems having a non-circularly-symmetric lens, using techniques such as astigmatism imaging or any other suitable imaging technique. The z position of an entity within a sample region may also be determined in microscopy systems with or without a non-circularly-symmetric lens using techniques such as off-focus imaging, multi-focal plane imaging, or any other suitable imaging technique. Typically, a non-circularly-symmetric lens is a lens that is not circularly symmetric with respect to the direction light emitted from a sample passes through the lens. For instance, the lens may be cylindrical, ellipsoidal, or the like. In some cases, the lens may have different radii of curvature in different planes. The cylindrical lens may also be a weak cylindrical lens, e.g., having a relatively long focal length, in certain embodiments. For example, the cylindrical lens may have a focal length of 100 mm or 1 m. In some embodiments, the non-circularly-symmetric lens can also be positioned relative to a sample region to define a focal region where at least a portion of the focal region does not contain the sample region. Light from an entity in a sample passing through a non-circularly symmetric lens may appear in an acquired image to be circular or elliptical. Non-circularly-symmetric lens may be obtained from various commercial sources.

The non-circularly-symmetric lens may be positioned on an optical or an imaging path extending from the sample region through an objective to a suitable detector, as discussed below. In some cases, more than one imaging path can pass through a non-circularly-symmetric lens. As an example, as is shown in FIG. 1B, two imaging paths, each of which extend through the sample region and one of the objectives positioned on either side of the sample region, are passed through a common non-circularly-symmetric lens (“CL”) before reaching a common detector (“CCD”).

In still other embodiments, there may be more than one non-circularly-symmetric lens present. As an example, if more than one detector is used, there may be non-circularly-symmetric lenses in imaging paths to some or all of the detectors. If more than one non-circularly-symmetric lens is present, the lenses may each independently be the same or different. In some cases, a non-circularly-symmetric lens can be positioned in a first imaging path in optical communication with a first objective, and optionally, a non-circularly-symmetric lens can also be positioned in a second imaging path in optical communication with a second objective.

The imaging path is not necessarily a straight line, although it can be in certain instances. The imaging path can be any path leading from the sample region, optionally through one or more optical components, to a detector such that the detector can be used to acquire an image of the sample region. Any of a variety of optical components may be present, and may serve various functions. For example, optical components may be present to guide the imaging path around the microscopy system, to reduce noise or unwanted wavelengths of light, or the like. Non-limiting examples of optical components that may be present within the imaging path (or elsewhere in the microscopy system, such as in an illumination path between a source of illumination and a sample region) include one or more optical components such as lenses, mirrors (for example, dichroic minors, polychroic minors, one-way mirrors, etc.), beam splitters, filters, slits, windows, prisms, diffraction gratings, optical fibers, and any number or combination of these may be present in various embodiments of the invention. One non-limiting example of a microscopy system containing several optical components in various imaging paths between a sample region through various objectives to a common detector is shown in FIG. 1B, and is discussed in more detail below.

The detector can be any device able to acquire one or more images of the sample region, e.g., via an imaging path. For example, the detector may be a camera such as a CCD camera, a photodiode, a photodiode array, a photomultiplier, a photomultiplier array, a spectrometer, or the like. The detector may be able to acquire monochromatic and/or polychromatic images, depending on the application. Those of ordinary skill in the art will be aware of detectors suitable for microscopy systems, and many such detectors are commercially available.

In one set of embodiments, a single detector is used, and multiple imaging paths may be routed to the common detector using various optical components such as those described herein. A common detector may be advantageous, for example, since no calibration or correction may need to be performed between multiple detectors. For instance, with a common detector, there may be no need to correct for differences in intensity, brightness, contrast, gain, saturation, color, etc. between different detectors. Thus, for example, a first image of the sample region can be projected onto a first location of the detector via a first imaging path, while a second image of the sample region can be projected onto a second location of the detector via a second imaging path. In some embodiments, images may be acquired by the detector simultaneously, e.g., as portions of the same overall frame acquired by the detector. This could be useful, for instance, to ensure that the images from the various objectives are properly synchronized with respect to time. Note that while these images may be acquired on the same frame within the detector, the images from the separate objectives are nevertheless generally referred to herein as separate images, although the separate images may represent different views of a common sample, or of a region within the common sample.

However, in other embodiments of the invention, more than one detector may be used, and the detectors may each independently be the same or different. In some cases, multiple detectors may be used, for example, to improve resolution and/or to reduce noise. For example, at least 2, at least 5, at least 10, at least 20, at least 25, at least 50, at least 75, at least 100, etc. detectors may be used, depending on the application. For example, a microscopy system can comprise a first detector in optical communication with a first objective via a first imaging path and a second detector in optical communication with a second objective via a second imaging path. This may be useful, for example, to simplify the collection of images via different imaging paths from different sides of the sample region. In some cases, more than two detectors may be present within the microscopy system.

The sample region is illuminated, in certain embodiments of the invention, using an illumination source that is able to illuminate at least a portion of the sample region via one or more illumination paths. Like the imaging path, the illumination path need not be a straight line, but may be any suitable path leading from the illumination source, optionally through one or more optical components, to at least a portion of the sample region.

In some embodiments, a portion of the illumination path may also coincide with a portion of the imaging path. As a non-limiting example, as is illustrated in FIG. 1B, part of an illumination path between an illumination source (at the end of the optical fiber) and the sample region passes through Objective 1 (“Obj. 1”) before reaching the sample region, while one of the imaging paths likewise passes through Objective 1. The imaging path and the illumination path proceed in different directions at a dichroic minor. However, this is not a requirement, as the example in FIG. 1A shows. Accordingly, at least some of the optical components that the illumination path passes through may be the same or different than the imaging paths. Non-limiting examples of optical components include any number of lenses, mirrors, beam splitters, filters, slits, windows, prisms, diffraction gratings, optical fibers, etc.

The illumination source may be any suitable source able to illuminate at least a portion of the sample region. The illumination source can be, e.g., substantially monochromatic or polychromatic. The illumination source may also be, in some embodiments, steady-state or pulsed. In some cases, the illumination source produces coherent light. In one set of embodiments, at least a portion of the sample region is illuminated with substantially monochromatic light, e.g., produced by a laser or other monochromatic light source, and/or by using one or more filters to remove undesired wavelengths. In some cases, more than one illumination source may be used, and each of the illumination sources may be the same or different. For example, in some embodiments, a first illumination source may be used to activate entities in a sample region, and a second illumination source may be used to excite entities in the sample region, or to deactivate entities in the sample region, or to activate different entities in the sample region, etc.

In one set of embodiments, the illumination path may reach the sample region at incidence angles at or slightly smaller than the critical angle for total internal reflection at the interface between the sample region and a glass substrate, e.g., a glass coverslide. In some cases, the illumination path can reach the sample region at incidence angles at or slightly smaller than the critical angle of the glass-water interface between the objective and the sample region. For instance, the incidence angle may be less than about 90°, less than about 80°, less than about 70°, less than about 60°, less than about 50°, less than about 40°, less than about 30°, less than about 20°, or less than about 10°. Typically, the incidence angle is defined as the angle between the light propagation direction and the direction normal to the sample.

In certain aspects, two or more objectives are used to obtain one or more images of a sample in a sample region. For example, a first plurality of images of a first side of a sample may be obtained via one objective, and a second plurality of images of a second side of the sample may be obtained via a second objective. In some cases, as previously discussed, more than two objectives may be present, e.g., focused on the same or different regions of the sample. In certain embodiments, an image from the first plurality of images and an image from the second plurality of images are compared to determine a position of an entity in the sample, e.g., if these two were obtained simultaneously or substantially simultaneously. Various properties of an entity within the first and second plurality of images can be compared. For instance, properties such as the position, shape, size, color, intensity, parallax, and/or appearance of the entity in the images can be compared. As specific non-limiting examples, the ellipticity of the appearance of an entity may be determined, or the degree of focus of the entity in the image may be determined.

For example, in one set of embodiments, an entity visible in both of the first and second pluralities of images, each obtained from different sides or angles of the sample, may be compared to determine the appearance of the entity in each of the pluralities of images. The images can be recorded by the same or different detectors, and in some cases, some or all of the images may be obtained simultaneously or substantially simultaneously. In some cases, based on this comparison, an entity can be accepted or rejected. For example, if an entity appears in a first image (e.g., from a first objective) but not in a second image (e.g., from a second objective), it may be determined that the entity is an artifact, and the entity could thereby be rejected. As another example, if the entity appears in both images, and appears to be in focus in both images (for example, as a single point, or a point with low spread in the image), it may be determined that the entity is in the focal plane of both objectives, and the entity can be accepted or rejected on that basis. As yet another example, if the entity is in focus in one image but not in another image, it may be determined that the entity is an artifact or “noise,” and the entity could thereby be rejected on that basis.

As another example, in some embodiments, an entity may be accepted or rejected based on a correlated or an anticorrelated property of the appearance of the entity in the first plurality of images formed by the first objective and the appearance of the entity in the second plurality of images formed by the second objective. For example, in one set of embodiments, a property of an entity in first and second plurality images is compared to determine if the property appears to be correlated or anticorrelated, and the entity can be accepted or rejected based on the anticorrelated or correlated property of the entity. Generally, an anticorrelated property is one that has a first appearance in a first image and an inversely-related appearance in a second image. For example, If the image of the entity formed by the first objective and the image of the entity formed by the second objective both appear elongated in the same direction, it may be that the property is correlated and the entity is an artifact or “noise,” and the entity could thereby be rejected on that basis.

Thus, according to certain embodiments, the noise level of images may be substantially reduced, thereby improving the precision or resolution of the final image (or data set). The amount of noise in the images can affect the quality of the images obtained using such techniques, and by removing such sources of noise, the resolution may be improved. By using techniques such as those described herein to eliminate a major source of uncertainty, the resolution of the final images (or data sets) may be significantly enhanced.

As a specific non-limiting example, as discussed below, the appearance of the shape and/or intensity of an entity in an image may be related to the position of the entity in the z direction, for instance, if a non-circularly-symmetric lens such as a cylindrical lens is used. Thus, for example, the ellipticity or elongated shape of the image of the entity may be a function of the distance between the entity and the focal plane of the objective. Accordingly, by determining the appearance of the entity in the first plurality of images and the appearance of the entity in the second plurality of images, the position of the entity in the z direction can be determined.

In some embodiments, starting with a plurality of images (e.g., a movie or a data set), some or all of the entities may be identified (e.g., through fluorescence, phosphorescence, etc.), and the positions of these entities can be determined. For example, the appearance of the entities in the images can be fit, in some cases, to Gaussian and/or elliptical Gaussian functions to determine their centroid positions, intensities, widths, ellipticities, etc. By determining the center or centroid position of the image of an entity using various techniques, for example, using average locations or least-squares fitting to a 2-dimensional Gaussian function of the intensity profile of the image, the location of the entity in the sample can be determined in the directions parallel to the focal plan (x and y), typically at a high (small) resolution. By determining the ellipticity of the image, for example, using least-squares fitting to a 2-dimensional Gaussian function of the intensity profile of the image, or to other suitable distributions, the location of the entity in the sample can be determined in the direction perpendicular to the focal plan (z), typically at a high (small) resolution. This process can be repeated as necessary for any or all of the entities within the image.

A final image or data set may be assembled or constructed from the positions of the entities or a subset of entities in the sample in some embodiments of the invention. In some cases, the data set may include position information of the entities in the x, y, and optionally z directions. As an example, the final coordinates of an entity may be determined as the average of the position of the entity as determined using each of the objectives, or as a weighted average of the position of the entity as determined using each of the objectives (e.g., weighted by the width of the image and/or number of photons obtained by each objective, etc.). The entities may also be colored in a final image in some embodiments, for example, to represent the degree of uncertainty, to represent the location of the entity in the z direction, to represent changes in time, etc. In one set of embodiments, a final image or data set may be assembled or constructed based on only the locations of the accepted entities while suppressing or eliminating the locations of the rejected entities.

As previously discussed, z direction information about entities within a sample may be obtained in certain embodiments. In some cases, the z positions can be determined at a resolution that is less than the diffraction limit of the incident light. In one set of embodiments, the emitted light may be processed, using Gaussian fitting, linear averaging, or other suitable techniques to localize the position of the emissive entities, e.g., as discussed herein. For example, for visible light, the z position of an entity can be determined at a resolution less than about 1000 nm, less than about 800 nm, less than about 500 nm, less than about 300, less than about 200 nm, less than about 100 nm, less than about 50 nm, less than about 40 nm, less than about 35 nm, less than about 30 nm, less than about 25 nm, less than about 20 nm, less than about 15 nm, or less than about 10 nm, using techniques such as these.

Any microscopy technique able to determine the z position of entity in a sample may be used in various embodiments of the invention. Non-limiting examples include astigmatism imaging, off-focus imaging, multi-focal plane imaging, or the like. In some cases, the entity may be positioned and imaged such that the entity does not appear as a single point of light, but as an image that has some area, for example, as a slightly unresolved or unfocused image. As a specific example, an entity can be imaged by a lens or a detector system that defines one or more focal regions (e.g., one or more focal planes) that do not contain the entity, such that the image of the entity at the detector appears unfocused. The degree to which the entity appears unfocused can be used to determine the distance between the entity and one of the focal regions, which can then be used to determine the z position of the entity.

In one set of embodiments, the z position can be determined using astigmatism imaging, for example, using a non-circularly-symmetric lens, as previously discussed. The size, shape, ellipticity, etc. of the image of an entity can be used, in some cases, to determine the distance between the entity and the focal region of the lens or the detector, which can be used to determine the z position of the entity in the sample. In some cases, the appearance of entities that are out of focus appear to be increasingly elliptical with distance from the focal plane, with the direction of ellipticity indicating whether the entity is above or below the focal plane.

In another set of embodiments, the z position can be determined using off-focus imaging. An entity not in one of the focal planes defined by an objective may appear to be unfocused, and the degree that the entity appears unfocused may be used to determine the distance between the entity and the focal plane, which can then be used to determine the z position. In some cases, the image of the unfocused entity may appear generally circular (with the area being indicative of the distance between the entity and the focal region of the lens), and in some instances, the image of the unfocused entity can appear as a series of ring-like structures, with more rings indicating greater distance).

In yet another set of embodiments, e.g., with multi-focal plane imaging, the light emitted by the entities may be collected by a plurality of detectors. In some cases, at one or more of the detectors, the light may appear to be unfocused. The degree that the images appear unfocused can be used to determine the z position in certain embodiments of the invention.

As previously discussed, imaging techniques such as these avoid interferometry, which typically requires optical components and configurations necessary to cause a photon to form its own coherent reference beam in order to interfere with itself. In contrast, optical techniques such as those described herein do not generally require precise alignment of a coherent reference beam.

In certain aspects of the invention, images of a sample may be obtained using stochastic imaging techniques. In many stochastic imaging techniques, various entities are activated and emit light at different times and imaged; typically the entities are activated in a random or “stochastic” manner. For example, a statistical or “stochastic” subset of the entities within a sample can be activated from a state not capable of emitting light at a specific wavelength to a state capable of emitting light at that wavelength. Some or all of the activated entities may be imaged (e.g., upon excitation of the activated entities), and this process repeated, each time activating another statistical or “stochastic” subset of the entities. Optionally, the entities are deactivated (for example, spontaneously, or by causing the deactivation, for instance, with suitable deactivation light). Repeating this process any suitable number of times allows an image of the sample to be built up using the statistical or “stochastic” subset of the activated emissive entities activated each time. Higher resolutions may be achieved in some cases because the emissive entities are not all simultaneously activated, making it easier to resolve closely positioned emissive entities. Non-limiting examples of stochastic imaging which may be used include stochastic optical reconstruction microscopy (STORM), single-molecule localization microscopy (SMLM), spectral precision distance microscopy (SPDM), super-resolution optical fluctuation imaging (SOFI), photoactivated localization microscopy (PALM), and fluorescence photoactivation localization microscopy (FPALM).

In certain embodiments, the resolution of the entities in the images can be, for instance, on the order of 1 micrometer or less, as described herein. In some cases, the resolution of an entity may be determined to be less than the wavelength of the light emitted by the entity, and in some cases, less than half the wavelength of the light emitted by the entity. For example, if the emitted light is visible light, the resolution may be determined to be less than about 700 nm. In some cases, two (or more) entities can be resolved even if separated by a distance of less than about 500 nm, less than about 300 nm, less than about 200 nm, less than about 100 nm, less than about 80 nm, less than about 60 nm, less than about 50 nm, or less than about 40 nm. In some cases, two or more entities separated by a distance of less than about 35 nm, less than about 30 nm, less than about 25 nm, less than about 20 nm, less than about 15 nm, or less than 10 nm can be resolved using embodiments of the present invention.

One non-limiting example of such a method is stochastic optical reconstruction microscopy (STORM). See, e.g., U.S. Pat. No. 7,838,302, issued Nov. 23, 2010, entitled “Sub-Diffraction Limit Image Resolution and Other Imaging Techniques,” by Zhuang, et al., incorporated herein by reference, for examples of STORM techniques. In STORM, incident light is applied to emissive entities within a sample in a sample region to activate the entities, where the incident light has an intensity and/or frequency that is able to cause a statistical subset of the plurality of emissive entities to become activated from a state not capable of emitting light (e.g., at a specific wavelength) to a state capable of emitting light (e.g., at that wavelength). Once activated, the emissive entities may spontaneously emit light, and/or excitation light may be applied to the activated emissive entities to cause these entities to emit light. The excitation light may be of the same or different wavelength as the activation light. The emitted light can be collected or acquired, e.g., in one, two, or more objectives as previously discussed. In some cases, the excitation light is also able to subsequently deactivate the statistical subset of the plurality of emissive entities, and/or the entities may be deactivated via other suitable techniques (e.g., by applying deactivation light, by applying heat, by waiting a suitable period of time, etc.). This process repeated as needed, each time with a statistically different subset of the plurality of emissive entities to emit light. In this way, a stochastic image of some or all of the emissive entities within a sample may be produced. In addition, as discussed herein, various image processing techniques, such as noise reduction and/or x, y and/or z position determination can be performed on the acquired images.

In some cases, incident light having a sufficiently weak intensity may be applied to a plurality of entities such that only a subset or fraction of the entities within the incident light are activated, e.g., on a stochastic or random basis. The amount of activation can be any suitable fraction, e.g., less than about 0.01%, less than about 0.03%, less than about 0.05%, less than about 0.1%, less than about 0.3%, less than about 0.5%, less than about 1%, less than about 3%, less than about 5%, less than about 10%, less than less than about 15%, less than about 20%, less than about 25%, less than about 30%, less than about 35%, less than about 40%, less than about 45%, less than about 50%, less than about 55%, less than about 60%, less than about 65%, less than about 70%, less than about 75%, less than about 80%, less than about 85%, less than about 90%, or less than about 95% of the entities may be activated, depending on the application. For example, by appropriately choosing the intensity of the incident light, a sparse subset of the entities may be activated such that at least some of them are optically resolvable from each other and their positions can be determined. In some embodiments, the activation of the subset of the entities can be synchronized by applying a short duration of incident light. Iterative activation cycles may allow the positions of all of the entities, or a substantial fraction of the entities, to be determined. In some cases, an image with sub-diffraction limit resolution can be constructed using this information.

Multiple locations on a sample can each be analyzed to determine the entities within those locations. For example, a sample may contain a plurality of various entities, some of which are at distances of separation that are less than the wavelength of the light emitted by the entities or below the diffraction limit of the emitted light. Different locations within the sample may be determined (e.g., as different pixels within an image), and each of those locations independently analyzed to determine the entity or entities present within those locations. In some cases, the entities within each location are determined to resolutions that are less than the wavelength of the light emitted by the entities or below the diffraction limit of the emitted light, as previously discussed.

The emissive entities may be any entity able to emit light. For instance, the entity may be a single molecule. Non-limiting examples of emissive entities include fluorescent entities (fluorophores) or phosphorescent entities, for example, fluorescent dyes such as cyanine dyes (e.g., Cy2, Cy3, Cy5, Cy5.5, Cy7, etc.), metal nanoparticles, semiconductor nanoparticles or “quantum dots,” or fluorescent proteins such as GFP (Green Fluorescent Protein). Other light-emissive entities are known to those of ordinary skill in the art. As used herein, the term “light” generally refers to electromagnetic radiation, having any suitable wavelength (or equivalently, frequency). For instance, in some embodiments, the light may include wavelengths in the optical or visual range (for example, having a wavelength of between about 380 nm and about 750 nm, i.e., “visible light”), infrared wavelengths (for example, having a wavelength of between about 700 micrometers and 1000 nm), ultraviolet wavelengths (for example, having a wavelength of between about 400 nm and about 10 nm), or the like. In certain cases, as discussed in detail below, more than one type of entity may be used, e.g., entities that are chemically different or distinct, for example, structurally. However, in other cases, the entities are chemically identical or at least substantially chemically identical.

In one set of embodiments, an emissive entity in a sample is an entity such as an activatable entity, a switchable entity, a photoactivatable entity, or a photoswitchable entity. Examples of such entities are discussed herein. In some cases, more than one type of emissive entity may be present in a sample. An entity is “activatable” if it can be activated from a state not capable of emitting light (e.g., at a specific wavelength) to a state capable of emitting light (e.g., at that wavelength). The entity may or may not be able to be deactivated, e.g., by using deactivation light or other techniques for deactivating light. An entity is “switchable” if it can be switched between two or more different states, one of which is capable of emitting light (e.g., at a specific wavelength). In the other state(s), the entity may emit no light, or emit light at a different wavelength. For instance, an entity can be “activated” to a first state able to produce light having a desired wavelength, and “deactivated” to a second state not able to produce light of the same wavelength.

If the entity is activatable using light, then the entity is a “photoactivatable” entity. Similarly, if the entity is switchable using light in combination or not in combination with other techniques, then the entity is a “photoswitchable” entity. For instance, a photoswitchable entity may be switched between different light-emitting or non-emitting states by incident light of different wavelengths. Typically, a “switchable” entity can be identified by one of ordinary skill in the art by determining conditions under which an entity in a first state can emit light when exposed to an excitation wavelength, switching the entity from the first state to the second state, e.g., upon exposure to light of a switching wavelength, then showing that the entity, while in the second state, can no longer emit light (or emits light at a reduced intensity) or emits light at a different wavelength when exposed to the excitation wavelength. Examples of switchable entities are discussed below, and are also discussed in U.S. Pat. No. 7,838,302, issued Nov. 23, 2010, entitled “Sub-Diffraction Limit Image Resolution and Other Imaging Techniques,” by Zhuang, et al., incorporated herein by reference.

In one set of embodiments, a switchable entity may be used. Non-limiting examples of switchable entities (including photoswitchable entities) are discussed in U.S. Pat. No. 7,838,302, issued Nov. 23, 2010, entitled “Sub-Diffraction Limit Image Resolution and Other Imaging Techniques,” by Zhuang, et al., incorporated herein by reference. As a non-limiting example of a switchable entity, Cy5 can be switched between a fluorescent and a dark state in a controlled and reversible manner by light of different wavelengths, e.g., 633 nm, 647 nm or 657 nm red light can switch or deactivate Cy5 to a stable dark state, while 405 nm or 532 nm green light can switch or activate the Cy5 back to the fluorescent state. Other non-limiting examples of switchable entities include fluorescent proteins or inorganic particles, e.g., as discussed herein. In some cases, the entity can be reversibly switched between the two or more states, e.g., upon exposure to the proper stimuli. For example, a first stimulus (e.g., a first wavelength of light) may be used to activate the switchable entity, while a second stimulus (e.g., a second wavelength of light or light with the first wavelength) may be used to deactivate the switchable entity, for instance, to a non-emitting state. Any suitable method may be used to activate the entity. For example, in one embodiment, incident light of a suitable wavelength may be used to activate the entity to be able to emit light, and the entity can then emit light when excited by an excitation light. Thus, the photoswitchable entity can be switched between different light-emitting or non-emitting states by incident light.

In some cases, the activation light and deactivation light have the same wavelength. In some cases, the activation light and deactivation light have different wavelengths. In some cases, the activation light and excitation light have the same wavelength. In some cases, the activation light and excitation light have different wavelengths. In some cases, the excitation light and deactivation light have the same wavelength. In some cases, the excitation light and deactivation light have different wavelengths. In some cases, the activation light, excitation light and deactivation light all have the same wavelength.

The light may be monochromatic (e.g., produced using a laser) or polychromatic. In another embodiment, the entity may be activated upon stimulation by electric fields and/or magnetic fields. In other embodiments, the entity may be activated upon exposure to a suitable chemical environment, e.g., by adjusting the pH, or inducing a reversible chemical reaction involving the entity, etc. Similarly, any suitable method may be used to deactivate the entity, and the methods of activating and deactivating the entity need not be the same. For instance, the entity may be deactivated upon exposure to incident light of a suitable wavelength, or the entity may be deactivated by waiting a sufficient time.

In one set of embodiments, the switchable entity can be immobilized, e.g., covalently, with respect to a binding partner, i.e., a molecule that can undergo binding with a particular analyte. Binding partners include specific, semi-specific, and non-specific binding partners as known to those of ordinary skill in the art. The term “specifically binds,” when referring to a binding partner (e.g., protein, nucleic acid, antibody, etc.), refers to a reaction that is determinative of the presence and/or identity of one or other member of the binding pair in a mixture of heterogeneous molecules (e.g., proteins and other biologics). Thus, for example, in the case of a receptor/ligand binding pair, the ligand would specifically and/or preferentially select its receptor from a complex mixture of molecules, or vice versa. Other examples include, but are not limited to, an enzyme would specifically bind to its substrate, a nucleic acid would specifically bind to its complement, an antibody would specifically bind to its antigen. The binding may be by one or more of a variety of mechanisms including, but not limited to ionic interactions, and/or covalent interactions, and/or hydrophobic interactions, and/or van der Waals interactions, etc. By immobilizing a switchable entity with respect to the binding partner of a target molecule or structure (e.g., DNA or a protein within a cell), the switchable entity can be used for various determination or imaging purposes. For example, a switchable entity having an amine-reactive group may be reacted with a binding partner comprising amines, for example, antibodies, proteins or enzymes.

In some embodiments, more than one switchable entity may be used, and the entities may be the same or different. In some cases, the light emitted by a first entity and the light emitted by a second entity have the same wavelength. The entities may be activated at different times and the light from each entity may be determined separately. This allows the location of the two entities to be determined separately and, in some cases, the two entities may be spatially resolved, even at distances of separation that are less than the wavelength of the light emitted by the entities or below the diffraction limit of the emitted light (i.e., “sub-diffraction limit” resolutions). In certain instances, the light emitted by a first entity and the light emitted by a second entity have different wavelengths (for example, if the first entity and the second entity are chemically different, and/or are located in different environments). The entities may be spatially resolved even at distances of separation that are less than the wavelength of the light emitted by the entities or below the diffraction limit of the emitted light. In certain instances, the light emitted by a first entity and the light emitted by a second entity have substantially the same wavelengths, but the two entities may be activated by light of different wavelengths and the light from each entity may be determined separately. The entities may be spatially resolved even at distances of separation that are less than the wavelength of the light emitted by the entities, or below the diffraction limit of the emitted light.

In some cases, the entities may be independently switchable, i.e., the first entity may be activated to emit light without activating a second entity. For example, if the entities are different, the methods of activating each of the first and second entities may be different (e.g., the entities may each be activated using incident light of different wavelengths). As another non-limiting example, if the entities are substantially the same, a sufficiently weak intensity of light may be applied to the entities such that only a subset or fraction of the entities within the incident light are activated, i.e., on a stochastic or random basis. Specific intensities for activation can be determined by those of ordinary skill in the art using no more than routine skill. By appropriately choosing the intensity of the incident light, the first entity may be activated without activating the second entity. The entities may be spatially resolved even at distances of separation that are less than the wavelength of the light emitted by the entities, or below the diffraction limit of the emitted light. As another non-limiting example, the sample to be imaged may comprise a plurality of entities, some of which are substantially identical and some of which are substantially different. In this case, one or more of the above methods may be applied to independently switch the entities. The entities may be spatially resolved even at distances of separation that are less than the wavelength of the light emitted by the entities, or below the diffraction limit of the emitted light.

In some embodiments, a microscope may be configured so to collect light emitted by the switchable entities while minimizing light from other sources of fluorescence (e.g., “background noise”). In certain cases, imaging geometry such as, but not limited to, a total-internal-reflection geometry, a spinning-disc confocal geometry, a scanning confocal geometry, an epi-fluorescence geometry, an epi-fluorescence geometry with an oblique incidence angle, etc., may be used for sample excitation. In some embodiments, as previously discussed, a thin layer or plane of the sample is exposed to excitation light, which may reduce excitation of fluorescence outside of the sample plane. A high numerical aperture lens may be used to gather the light emitted by the sample. The light may be processed, for example, using filters to remove excitation light, resulting in the collection of emission light from the sample. In some cases, the magnification factor at which the image is collected can be optimized, for example, when the edge length of each pixel of the image corresponds to the length of a standard deviation of a diffraction limited spot in the image.

In some embodiments of the invention, the switchable entities may also be resolved as a function of time. For example, two or more entities may be observed at various time points to determine a time-varying process, for example, a chemical reaction, cell behavior, binding of a protein or enzyme, etc. Thus, in one embodiment, the positions of two or more entities may be determined at a first point of time (e.g., as described herein), and at any number of subsequent points of time. As a specific example, if two or more entities are immobilized relative to a common entity, the common entity may then be determined as a function of time, for example, time-varying processes such as movement of the common entity, structural and/or configurational changes of the common entity, reactions involving the common entity, or the like. The time-resolved imaging may be facilitated in some cases since a switchable entity can be switched for multiple cycles, with each cycle giving one data point of the position of the entity.

In some cases, one or more light sources may be time-modulated (e.g., by shutters, acoustic optical modulators, or the like). Thus, a light source may be one that is activatable and deactivatable in a programmed or a periodic fashion. In one embodiment, more than one light source may be used, e.g., which may be used to illuminate a sample with different wavelengths or colors. For instance, the light sources may emanate light at different frequencies, and/or color-filtering devices, such as optical filters or the like, may be used to modify light coming from the light sources such that different wavelengths or colors illuminate a sample.

Various image-processing techniques may also be used to facilitate determination of the entities. For example, drift correction or noise filters may be used. Generally, in drift correction, a fixed point is identified (for instance, as a fiduciary marker, e.g., a fluorescent particle may be immobilized to a substrate), and movements of the fixed point (i.e., due to mechanical drift) are used to correct the determined positions of the switchable entities. In another example method for drift correction, the correlation function between images acquired in different imaging frames or activation frames can be calculated and used for drift correction. In some embodiments, the drift may be less than about 1000 nm/min, less than about 500 nm/min, less than about 300 nm/min, less than about 100 nm/min, less than about 50 nm/min, less than about 30 nm/min, less than about 20 nm/min, less than about 10 nm/min, or less than 5 nm/min. Such drift may be achieved, for example, in a microscope having a translation stage mounted for x-y positioning of the sample slide with respect to the microscope objective. The slide may be immobilized with respect to the translation stage using a suitable restraining mechanism, for example, spring loaded clips. In addition, a buffer layer may be mounted between the stage and the microscope slide. The buffer layer may further restrain drift of the slide with respect to the translation stage, for example, by preventing slippage of the slide in some fashion. The buffer layer, in one embodiment, is a rubber or polymeric film, for instance, a silicone rubber film.

Accordingly, one embodiment of the invention is directed to a device comprising a translation stage, a restraining mechanism (e.g., a spring loaded clip) attached to the translation stage able to immobilize a slide, and optionally, a buffer layer (e.g., a silicone rubber film) positioned such that a slide restrained by the restraining mechanism contacts the buffer layer. To stabilize the microscope focus during data acquisition, a “focus lock” device may be used in some cases. As a non-limiting example, to achieve focus lock, a laser beam may be reflected from the substrate holding the sample and the reflected light may be directed onto a position-sensitive detector, for example, a quadrant photodiode. In some cases, the position of the reflected laser, which may be sensitive to the distance between the substrate and the objective, may be fed back to a z-positioning stage, for example a piezoelectric stage, to correct for focus drift.

Another aspect of the invention is directed to a computer-implemented method. For instance, a computer and/or an automated system may be provided that is able to automatically and/or repetitively perform any of the methods described herein. As used herein, “automated” devices refer to devices that are able to operate without human direction, i.e., an automated device can perform a function during a period of time after a human has finished taking any action to promote the function, e.g., by entering instructions into a computer. Typically, automated equipment can perform repetitive functions after this point in time. The processing steps may also be recorded onto a machine-readable medium in some cases.

In some cases, a computer may be used to control excitation of the switchable entities and the acquisition of images of the switchable entities. In one set of embodiments, a sample may be excited using light having various wavelengths and/or intensities, and the sequence of the wavelengths of light used to excite the sample may be correlated, using a computer, to the images acquired of the sample containing the switchable entities. For instance, the computer may apply light having various wavelengths and/or intensities to a sample to yield different average numbers of activated switchable elements in each region of interest (e.g., one activated entity per location, two activated entities per location, etc.). In some cases, this information may be used to construct an image of the switchable entities, in some cases at sub-diffraction limit resolutions, as noted above.

Still other embodiments of the invention are generally directed to a system able to perform one or more of the embodiments described herein. For example, the system may include a microscope, a device for activating and/or switching the entities to produce light having a desired wavelength (e.g., a laser or other light source), a device for determining the light emitted by the entities (e.g., a camera, which may include color-filtering devices, such as optical filters), and a computer for determining the spatial positions of the two or more entities.

In other aspects of the invention, the systems and methods described herein may also be combined with other imaging techniques known to those of ordinary skill in the art, such as high-resolution fluorescence in situ hybridization (FISH) or immunofluorescence imaging, live cell imaging, confocal imaging, epi-fluorescence imaging, total internal reflection fluorescence imaging, etc.

The following documents are incorporated herein by reference in their entireties: International Patent Application No. PCT/US2008/013915, filed Dec. 19, 2008, entitled “Sub-diffraction Limit Image Resolution in Three Dimensions,” by Zhuang, et al., published as WO 2009/085218 on Jul. 9, 2009; U.S. Pat. No. 7,776,613, issued Aug. 17, 2010, entitled “Sub-Diffraction Image Resolution and Other Imaging Techniques,” by Zhuang, et al.; and U.S. Pat. No. 7,838,302, issued Nov. 23, 2010, entitled “Sub-Diffraction Limit Image Resolution and Other Imaging Techniques,” by Zhuang, et al. Also incorporated herein by reference in its entirety is U.S. Provisional Patent Application Ser. No. 61/576,089, filed Dec. 15, 2011, entitled “High Resolution Dual-Objective Microscopy,” by Zhuang, et al.

The following examples are intended to illustrate certain embodiments of the present invention, but do not exemplify the full scope of the invention.

### Example 1

Recent advances in super-resolution fluorescence microscopy have substantially improved the spatial resolution of optical imaging. The enhanced resolution has enabled the visualization of various cellular ultrastructures previously inaccessible to optical methods. Nonetheless, the current state-of-the-art resolution still cannot resolve many cellular structures, and further improvement of the resolution is desirable.

For example, among the three major types of cytoskeletal structures, individual microtubules and intermediate filaments can be routinely observed in cells with optical microscopy; by contrast, individual actin filaments have not been resolved in cells by optical techniques, including super-resolution methods, due to the small diameter and high packing density of actin filaments. Actin is of vital importance to many cellular processes. In particular, the assembly and disassembly of actin filaments in the thin sheet-like cell protrusions drive cell locomotion. The knowledge of how actin filaments are spatially organized is important for understanding these processes. While electron microscopy (EM) and cryo-electron tomography can resolve individual actin filaments in cells, three-dimensional (3D) reconstructions are still relatively challenging due in part to the structural perturbations induced by the dehydration and embedding treatment required for conventional EM and the difficulty in reconstructing large volumes by cryo-tomography. Therefore, except for the several hundred nanometers near the cell edge, a full 3D reconstruction of actin has not been achieved for the sheet-like cell protrusion, and how actin is vertically organized in this region is still unclear.

This example illustrates super-resolution fluorescence microscopy by combining 3D stochastic optical reconstruction microscopy (STORM) with a dual-objective detection scheme (FIG. 1B). In one embodiment of the 3D STORM technique, an optically resolvable subset of fluorescent probes are activated at any given instant, and their signals are detected using a single objective. Astigmatism is introduced in the detection path using a cylindrical lens such that the images obtained for individual molecules are elongated in x and y directions for molecules on the proximal and distal sides of the focal plane, respectively. The lateral and axial coordinates of the molecules are determined from the centroid positions and ellipticities of these single-molecule images, respectively. Iteration of the activation and imaging cycles allows the positions of numerous molecules to be determined and a super-resolution image to be reconstructed from these molecular coordinates. For additional details, see International Patent Application No. PCT/US2008/013915, filed Dec. 19, 2008, entitled “Sub-diffraction Limit Image Resolution in Three Dimensions,” by Zhuang, et al., published as WO 2009/085218 on Jul. 9, 2009, incorporated herein by reference in its entirety.

The 3D STORM method can be combined with a two-objective detection scheme to increase the image resolution of super-resolution fluorescence microscopy. In FIG. 1B, two microscope objectives are placed opposing each other and aligned so that they focus on the same spot of the sample. The sample, sandwiched between the two objectives, is illuminated with 647 nm and 405 nm lasers (using an optical fiber) through one of the objectives, and the fluorescence emission is collected by both objectives and projected onto two different areas of a single CCD camera. Astigmatism is introduced into the imaging path of both objectives using a cylindrical lens.

It may be reasoned that the total collected fluorescence signal would double by sandwiching the sample between two opposing objectives and detecting the signal from both objectives. Since the localization uncertainty of each molecule scales with the inverse square root of the number of photons detected, doubling the photon count would be expected to yield, at best, a 1.4-fold improvement in the image resolution. However, as discussed below, much higher resolutions were actually obtained.

To characterize the localization precision of the dual-objective STORM setup, individual Alexa 647 molecules scattered in fixed cells within ˜150 nm of the focal plane were imaged. This range is generally comparable to the thickness of the sheet-like cell protrusions. While in these experiments, the imaging z-range was limited to be comparable to the thickness of cell protrusions, the imaging depth could be readily increased by stepping the sample in the z-direction. As each Alexa 647 molecule can be switched on and off multiple times, the standard deviation (SD) of repetitive localizations of the same molecule allowed an experimental determination of the localization precision.

Surprisingly, the measured localization precisions, ˜4 nm and ˜8 nm in x-y and z directions, respectively (FIG. 1C), represent a greater than two-fold improvement over previously reported values with the same fluorophore using one objective using 3D STORM techniques. This localization precision corresponds to an image resolution of ˜9 nm in the lateral directions and ˜19 nm in the axial direction, measured in full width at half maximum (FWHM).

FIG. 1C shows the localization precision of Alexa 647 molecules in fixed cells measured with this dual-objective system. Each molecule gives a cluster of localizations due to repetitive activation of the same molecule. Localizations from 108 clusters (each containing >10 localizations) are aligned by their center of mass to generate the 3D presentation of the localization distribution. Histograms of the distribution in x, y, and z are fit to Gaussian functions, and the resultant standard deviations (σₓ, σ_{y}, and σ_{z}) are given in the plots.

The measured localization precision and image resolution are significantly higher than would have been predicted solely by doubling the photon collection efficiency with the use of two objectives, as discussed above. Indeed, at these length scales—less than 10 nm—any further significant improvements in resolution is both unexpected and important.

Further examination of the single-molecule images showed that beyond the expected doubling of photon-collection efficiency (FIG. 1D), the combination of astigmatism imaging and dual-objective detection provided a noise-cancelling mechanism that further improved image precision (FIG. 1E). FIG. 1D shows the distribution of the number of photons detected for individual Alexa 647 molecules through both objectives (Ave=10,600) in comparison to that detected from a single objective (Ave=5,200).

FIG. 1E shows images of activated Alexa 647 molecules obtained from the two objectives in a single frame, which demonstrates the anticorrelated appearance of entities in this particular embodiment of the invention. The scale bar is 2 micrometers. Molecules that were axially closer to one of the objectives were necessarily farther from the opposing one, resulting in anticorrelated changes in the ellipticity detected by the two objectives (FIG. 1E, left and center arrows). Thus, an entity that appears elongated in x through one objective should appear elongated in y through the opposing objective. In contrast, noise (such as those caused by sample drift) and abnormalities (such as two nearby molecules with overlapping images that are misidentified as a single molecule) led to correlated changes (FIG. 1E, right arrows). This effect allowed noises to be cancelled by averaging the z measurements from the two channels, and abnormalities to be identified and rejected by examining the difference in the z-positions obtained from the two objectives. In addition, the mechanical stability of the dual-objective setup (with the optical axis of the objectives parallel to the optical table and the sample vertical oriented) was found to be higher than that of the single-objective setup built on a standard inverted microscope with the optical axis of the objectives perpendicular to the optical table. These effects resulted in a substantial improvement of the spatial resolution.

### Example 2

This example illustrates imaging of an actin cytoskeleton using a configuration similar to the one discussed in Example 1. To benefit from high image resolution, the target structure was labeled using small organic molecules, by staining the actin filaments with Alexa 647 dye labeled phalloidin, which binds actin filaments with high specificity. Imaging using certain STORM techniques was performed through the direct activation of Alexa 647 using short-wavelength light. See, e.g., U.S. Pat. No. 7,838,302, issued Nov. 23, 2010, entitled “Sub-Diffraction Limit Image Resolution and Other Imaging Techniques,” by Zhuang, et al., or International Patent Application No. PCT/US2008/013915, filed Dec. 19, 2008, entitled “Sub-diffraction Limit Image Resolution in Three Dimensions,” by Zhuang, et al., published as WO 2009/085218 on Jul. 9, 2009, each incorporated herein by reference.

FIG. 2 compares the conventional and dual-objective STORM images of actin in a fibroblast (COS-7) cell. FIG. 2A shows a dual-objective image of actin (labeled with Alexa 647-phalloidin) in a COS-7 cell. The z-positions are shown using shading. The scale bar is 2 micrometers. FIGS. 2B, 2C and 2D illustrate a close-up comparison between the dual-objective STORM image (FIG. 2B) with a single-objective STORM image (FIG. 2C) and a conventional fluorescence image (FIG. 2D) of the boxed region in FIG. 2A. The scale bar in these figures is 500 nm. FIG. 2E shows a cross-sectional profile of eight filaments overlaid by the center of each filament. The smooth line is a Gaussian fit with FWHM of 12 nm. FIG. 2F shows a cross-sectional profile for two nearby filaments obtained in the dual-objective image (identified in FIGS. 2B and 2C by arrows) in comparison to the profile obtained in the single-objective image. The grey bars correspond to the dual-objective images in FIG. 2B and the line corresponds to the single objective image in FIG. 2C.

In contrast with the conventional fluorescence image, in which actin filaments were completely unresolvable (FIG. 2D), actin filaments were clearly resolved in dual-objective STORM images (FIG. 2B). The cross-sectional profile of individual filaments exhibited a 12 nm FWHM (FIG. 2E). After subtracting the effect of the 9-nm lateral image resolution, the width of the phalloidin-labeled actin filaments was found to be ˜8 nm (=(12²-9²)^{1/2}), which agrees with the known diameter of actin (5 nm to 9 nm). In addition, nearby filaments separated by ˜20 nm were well resolved from each other (FIG. 2F). In comparison, lower resolution was achieved if one only relies on the information collected by one of the two objectives (FIGS. 2C and 2F)

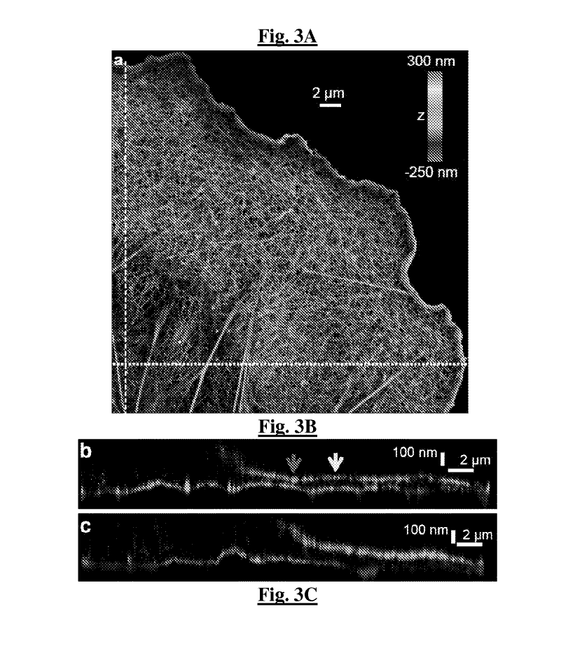

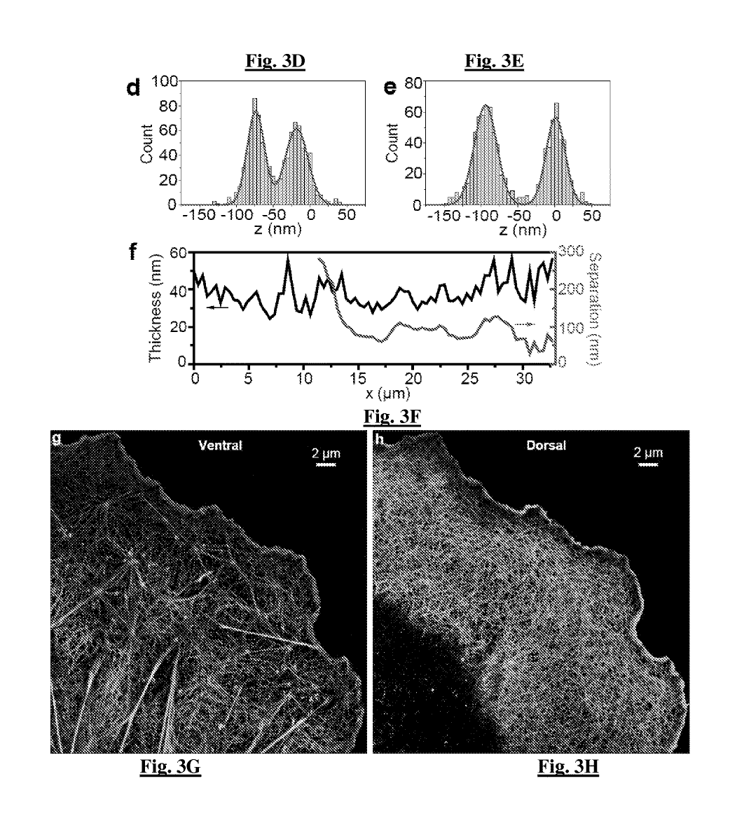

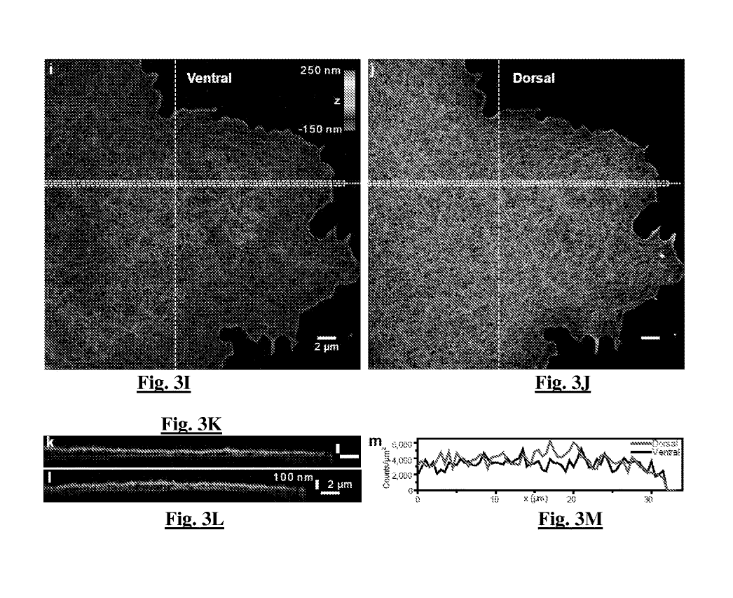

The volumetric imaging capability with the 9-nm lateral and 19-nm axial resolutions further allowed a holistic, 3D view of the actin networks to be obtained. Referring now to FIG. 3, FIG. 3A shows a dual-objective image of actin in an epithelial (BSC-1) cell. The z-positions are shown as shading. FIGS. 3B and 3C show vertical cross sections (each 500 nm wide in x or y) of the cell in FIG. 3A, along the dot and dash lines, respectively. Note when far from the cell edge, the z-position of the dorsal layer increases quickly and falls out of the imaging range used in this example. FIGS. 3D and 3E show z-profiles for two points along the vertical section, corresponding to the left and right arrows in FIG. 3B, respectively. Each histogram is fit to two Gaussians (curves), yielding the apparent thickness of the ventral and dorsal layers and the peak separation between the two layers. FIG. 3F shows quantification of the apparent thickness averaged over the two layers and the dorsal-ventral separation obtained from the x-z cross-section profile in FIG. 3B. FIGS. 3G and 3H show the ventral and dorsal actin layers of the cell in FIG. 3A. FIGS. 3I and 3J show the ventral and dorsal actin layers of a COS-7 cell that was treated with blebbistatin. FIGS. 3K and 3L show vertical cross sections (each 500 nm wide in x or y) of the blebbistatin-treated cell along the dot and dash lines, respectively. FIG. 3M shows the actin density of the ventral and dorsal layers along the horizontal boxes in FIGS. 3I and 3J, measured by the localization density. The scale bars are 2 micrometers for FIGS. 3A, 3G, 3H, 3I, and 3J, and 100 nm for z and 2 micrometers for x and y for FIGS. 3B, 3C, 3K, and 3L.

In these figures, two vertically separated actin layers were observed in the sheet-like cell protrusion despite its small thickness (FIGS. 3A-3C). Each of these layers was apparently about 30 to about 40 nm thick (FIGS. 3D-3F). The separation between the two layers was generally ˜100 nm, but could be as small as ˜50 nm (FIGS. 3D-3F). The separation increased to much larger than 200 nm in the interior region far from the cell edge, suggesting that the two layers evolve into the cortical actin layers in the cell body. The two layer organization was also validated in living cells.

Although filaments in the two layers formed well separated networks, thick filament bundles occasionally connected the two layers. Such bundles typically originated from adhesion plaques, ran through the ventral layer, and gradually rose towards and ultimately reached the dorsal layer, as expected for the dorsal stress fibers. Thick bundles connecting adhesion plaques on the ventral surface, as expected for ventral stress fibers, were also observed. In addition to these mature focal adhesions at the end of the thick actin bundles, smaller and more isotropic adhesion complexes were also observed, likely representing nascent adhesions complexes. Actin filaments attached to these structures diverged in different directions and often connected nearby adhesion plaques.

Remarkably, the two layers of actin networks exhibited highly distinct spatial organizations of actin filaments (FIGS. 3G and 3H). While the dorsal layer typically appeared as a consistently dense and homogeneous meshwork, the ventral layer formed a web-like structure with a lower filament density and highly variable organization. The two-layer arrangement was consistently observed in all BSC-1 epithelial cells that were imaged as well as in COS-7 fibroblast cells. The actin density in the dorsal layer could be several times as high as that in the ventral layer. Additional analysis suggests that the two layer arrangement spans the lamellum and possibly extends into the lamellipodium.

To explore the molecular mechanisms underlying the structural differences observed for the two actin networks, how these networks responded to different actomyosin-perturbing drugs was investigated. Cytochalasin D, a drug that inhibits actin polymerization, reduced the filament density as expected. Latrunculin A, a drug that sequesters monomeric actin, also reduced the filament density as expected, but with the dorsal network substantially more disrupted than the ventral layer, suggesting that the dorsal layer is potentially more dynamic and thus more readily disrupted by actin monomer depletion. Interestingly, blebbistatin, an inhibitor for myosin II, completely removed the structural differences between the ventral and dorsal networks: both networks became uniform actin meshworks of similar density, reminiscent of the dense, uniform dorsal network observed in untreated cells (FIGS. 3I-M). These results suggest that myosin II plays a key role in the structural reorganization of the ventral actin layer and in maintaining the structural differences between the dorsal and ventral actin networks. This function of myosin II is potentially related to its activities previously found in regulating actin disassembly, actin bundle formation, and focal adhesion maturation.

In summary, by combining astigmatism imaging, dual-objective detection and small-molecule labeling in STORM, image resolutions of <10 nm in the lateral directions and <20 nm in the axial direction may be obtained. This lateral resolution is 2-fold or more higher than previously achieved for biological samples using other super-resolution methods. Although higher axial resolutions have been reported using interferometry approaches, the astigmatism-based system reported here is substantially simpler to implement.

With the improved resolution, these examples illustrate the resolution of individual actin filaments in cells for the first time using fluorescence microscopy, which opens a new window for studying numerous actin-related processes in cells. These examples also illustrate the 3D ultrastructure of the actin cytoskeleton in sheet-like cell protrusions and revealed two layers of continuous actin networks with distinct structures, which both supports and extends previous understandings. In addition to these examples, the high image resolution obtained with dual-objective STORM should also find use in many other systems.

### Example 3

This example describes the optical setup used in Examples 1 and 2. A schematic of the dual-objective setup is shown in FIG. 1B. Two infinity-corrected microscope objectives (Olympus Super Apochromat UPLSAPO 100×, oil immersion, NA 1.40) were placed opposing each other and aligned so they focus on the same spot of the sample. A piezoelectric actuator (Thorlabs DRV120) was used to control the axial position of the sample with nanometer precision. The 647 nm line from a Kr/Ar mixed gas laser (Innova 70C Spectrum, Coherent) and the 405 nm beam from a solid state laser (CUBE 405-50C, Coherent) were introduced into the sample through the back focal plane of the first objective using a customized dichroic minor that worked at an incident angle of 22.5° (Chroma). A translation stage allowed the laser beams to be shifted towards the edge of the objective so that the emerging light reached the sample at incidence angles slightly smaller than the critical angle of the glass-water interface, thus illuminating only the fluorophores within a few micrometers of the coverslip surface. The fluorescence emission was collected by both objectives. After passing through long-pass filters (HQ665LP, Chroma), the two parallel light rays from the two objectives were each focused by a 20 cm achromatic lens, cropped by a slit at the focal plane, and then separately projected onto two different areas of the same EMCCD camera (Andor iXon DU-897) using two pairs of relay lenses. Astigmatism was introduced into the imaging paths of both objectives using a cylindrical lens so that the images obtained by each objective were elongated in x and y for molecules on the proximal and distal sides of the focal plane (relative to the objective), respectively. A band-pass filter (ET700/75m, Chroma) was installed on the camera.

Following is one example of a procedure for setting up the optical setup discussed above.

Combine different laser lines using dichroic mirrors and/or prisms. For studies using Alexa 647 dye labels, a red laser (e.g., the 647 nm line from a Kr/Ar mixed gas laser or a 656 nm solid state laser) and a violet or UV laser (e.g., a 405 nm solid state laser) can be used. An AOTF (acousto-optical tunable filter) may be used to control both the shuttering and the light intensity for different laser lines. Couple the combined laser lights into the optical fiber.

Combine the 2D translation stage with a 1D translation stage to obtain 3D control of the sample position. For actuation of the 1D translation stage (e.g., for z positioning of the sample), combine a DRV120 piezoelectric actuator with a DRV3 manual actuator to obtain both a large (8 mm) working distance for coarse alignment (DRV3) and nanometer precision (e.g., within a range of ˜20 micrometers) for fine adjustments (DRV120). Center the sample stage for initial alignment.

Mount Objective 1 (“Obj. 1”) using a z-axis translation mount. Use a calibration slide as the sample and illuminate from the opposite side with white light (this can be easily done as Objective 2 (“Obj. 2”) has not been installed yet at this step). Add in the 22.5° dichroic mirror and the tube lens (L3) for Objective 1, and place Slit 1 at the intermediate image formed after L3 and M3. Open the slit. Project the image onto the EMCCD camera using a pair of relay lenses (L4 and L5). Align the camera so that the center of the image is projected onto the center of the right half of the CCD. Use Slit 1 to crop the image so that when looking at the acquired camera signal on the computer screen, the image is restrained to only one half of the camera.

Collimate the laser light coming out of the end of the optical fiber and introduce it into the sample through the back focal plane of Objective 1. Place M1, M2, and L2 on a 1D translation stage so the laser beam can be shifted to the edge of the objective during imaging. During initial alignment, however, pass the laser beam through the center of Objective 1 and make sure that the laser is parallel to the axis of the objective by adjusting M1 and M2. Multiple irises can be placed along the light path to check the alignment.

Mount Objective 2 with an x-y translator. Illuminate the calibration slide through Objective 1 using a weak laser and add in M5, L6, Slit 2, L7, M6, and L8 sequentially, similar to that was done for Objective 1, but project the final image onto the left half of the CCD instead.

Insert the two long-pass filters (LP1 and LP2) into the two optical paths. Add in the cylindrical lens after the relay lenses (L5 and L8) of the optical paths for both Objective 1 and Objective 2. Install the band-pass filter on the camera.

Assemble a fluorescent bead sample with coverslips on both sides. Replace the calibration slide with the bead sample. Use the 647 nm laser to illuminate the sample. Use the DRV120-DRV3 actuator system (Step 2) to adjust the z-position of the sample so that the beads are in focus for Objective 1. Align Objective 2 by adjusting the x-y translator and the z-axis translation mount so that Objective 1 and Objective 2 focus on the same spot of the bead sample. Make fine adjustments to Slit 1 and Slit 2 while observing the acquired camera signal on the computer screen, to ensure that the two images obtained via Objective 1 and Objective 2 each occupies one-half of the CCD without overlapping.

For single molecule imaging, background light should be reduced or eliminated. For example, a box can be built around the camera and the relay lenses, as illustrated in the schematic diagram in FIG. 1B.

To enhance image contrast, adjust the translation stage for the incoming laser beam to shift it to the edge of Objective 1, so that the emerging light reaches the sample at incidence angles slightly smaller than the critical angle of the glass-water interface, thus illuminating only the fluorophores within a few micrometers of the coverslip surface.

For imaging of the Alexa 647 labeled actin, use 647 nm laser (˜2 kW/cm²) to excite fluorescence from Alexa 647 molecules and switch them into the dark state. Use the 405 nm laser to reactivate the fluorophores from the dark state back to the emitting state. Adjust the power of the 405 nm laser (0 W/cm² to 1 W/cm²) during image acquisition so that at any given instant, only a small, optically resolvable fraction of the fluorophores in the sample were in the emitting state. See, e.g., U.S. Pat. No. 7,838,302, issued Nov. 23, 2010, entitled “Sub-Diffraction Limit Image Resolution and Other Imaging Techniques,” by Zhuang, et al., or International Patent Application No. PCT/US2008/013915, filed Dec. 19, 2008, entitled “Sub-diffraction Limit Image Resolution in Three Dimensions,” by Zhuang, et al., published as WO 2009/085218 on Jul. 9, 2009, each incorporated herein by reference, for more details of STORM imaging.

It should be noted that the above discussion is only one example of a procedure for setting up the optical setup shown in FIG. 1B, and other techniques may also be used. In addition, other optical setups may also be used in other embodiments of the invention besides the one illustrated in FIG. 1B.

### Example 4

Following are various protocols useful in the examples discussed above. Sample preparation. BSC-1 and COS-7 cells were plated on 18-mm diameter, #1.5 uncoated glass coverslips at a confluency of ˜20%. After 16-24 hours, the cells were fixed and labeled following previously developed protocols for ultrastructural studies of actin cytoskeleton. Briefly, the cells were initially fixed and extracted for 1-2 min using a solution of 0.3% glutaraldehyde and 0.25% Triton X-100 in cytoskeleton buffer (CB: 10 mM MES pH 6.1, 150 mM NaCl, 5 mM EGTA, 5 mM glucose, and 5 mM MgCl₂), and then post-fixed for 10 min in 2% glutaraldehyde in CB. The sample was treated with freshly-prepared 0.1% sodium borohydride for 7 min to reduce background fluorescence. For vinculin staining (when needed), the sample was first blocked with 3% BSA and 0.5% Triton X-100, and then stained with rabbit monoclonal vinculin antibodies (Invitrogen 700062) followed by Cy3-labeled goat anti-rabbit secondary antibodies (Invitrogen A10520). Actin filaments were labeled with Alexa Fluor 647-phalloidin (Invitrogen A22287) overnight at 4° C. A concentration of ˜0.5 micromolar phalloidin in phosphate buffered saline (PBS) was used. To minimize the dissociation of phalloidin from actin, the sample was briefly washed once with PBS and then immediately mounted for STORM imaging.

For drug-effect studies, cells were incubated with culture media containing either 0.5 micromolar cytochalasin D (Sigma-Aldrich), 0.25 micromolar latrunculin A (Invitrogen), or 50 micromolar (−)-blebbistatin (the active enantiomer; Sigma-Aldrich) at 37° C. for 1 hour, and then fixed and labeled as described above.

The imaging buffer for fixed cells was PBS with the addition of 100 mM cysteamine, 5% glucose, 0.8 mg/mL glucose oxidase (Sigma-Aldrich), and 40 micrograms/mL catalase (Roche Applied Science). ˜4 microliters of imaging buffer was dropped at the center of a freshly-cleaned, #1.5 rectangular coverslip (22 mm by 60 mm), and the sample on the 18-mm diameter coverslip was mounted on the rectangular coverslip and sealed with nail polish.

Image data acquisition. The sealed sample was mounted between the two opposing objectives. The 647 nm laser was used to excite fluorescence from Alexa Fluor 647 molecules. Prior to acquiring images, a relatively weak 647 nm light (˜0.05 W/cm²) was used to illuminate the sample and recorded the conventional fluorescence image before any substantial fraction of the dye molecules were switched off. The 647 nm light intensity was then increased (to ˜2 kW/cm²) to rapidly switch the dyes off for STORM imaging. The 405 nm laser was used to reactivate the fluorophores from the dark state back to the emitting state. The power of the 405 nm laser (0-1 W/cm²) was adjusted during image acquisition so that at any given instant, only a small, optically resolvable fraction of the fluorophores in the sample were in the emitting state. The EMCCD camera acquired images from both objectives simultaneously at a frame rate of 60 Hz. Typically, ˜90,000 frames were recorded to generate the final super-resolution images. Recording of more frames (e.g., 230,000 frames for FIG. 2) further improved the image quality at the expense of longer imaging time.

Image data analysis. The recorded data were first split into two movies, each of which comprised a sequence of images obtained by one of the two objectives. Each movie was first analyzed separately according to previously described methods (see, e.g., U.S. Pat. No. 7,838,302, incorporated herein by reference). The centroid positions and ellipticities of the single-molecule images provided lateral and axial positions of each activated fluorescent molecule, respectively. The molecular positions obtained by the second objective were mapped to the coordinates of the first objective through a transformation based on corresponding features (control points) in both images. The mapped data from the two objectives were then compared frame-by-frame: molecules that were switched on within one-frame of time and that were within ˜50 nm to each other in the mapped x-y plane were identified as the same emitting molecule detected by both objectives. Non-matching molecules were discarded. For each pair of matched molecules observed by the two objectives, the availability of two z-positions obtained through the two objectives provides a technique to identify abnormalities and cancel noise. Since the focal planes of the two opposing objectives coincided, a molecule on the side of the focal plane proximal to one objective would be on the distal side for the other objective. Therefore, its image would appear elongated in x through one objective but elongated in y through the other objective. A real change in the z position would cause anticorrelated changes in ellipticity measured through the two objectives (FIG. 1E, left and center arrows). On the other hand, abnormalities and noise would tend to cause correlated changes in ellipticity. For example, when two close-by molecules with overlapping images were misidentified as a single molecule, the resultant images through both objectives would appear elongated in the same direction along the line connecting the two molecules (FIG. 1E, right arrows). Likewise, any x-y drift of the stage or the camera would also cause elongation in the same direction. These correlated changes in ellipticity resulted in apparently different z positions obtained through the two objectives (delta-z). The value of delta-z (Δz) could thus be used to identify and reject abnormalities. These abnormalities (identified by delta-z>100 nm, which is substantially larger than the axial resolution of a single objective) amounted to ˜10% of all identified entities. For molecule pairs that matched well with each other in all four (spatial and temporal) coordinates, the final coordinates were determined as the average of the mapped coordinates from the two objectives, weighted by the width of the image and number of photons obtained by each objective. This averaging procedure further reduced noise caused by errors, such as the correlated changes in ellipticity described above. The final super-resolution images were reconstructed from these molecular coordinates by depicting each location as a 2D Gaussian peak.

To characterize the localization precision, fixed cell samples sparsely labeled with Alexa Fluor 647 were used. Relatively strong activation conditions were used such that each Alexa Fluor 647 molecule was activated multiple times during the image acquisition time and gave a cluster of localizations due to the repetitive activation. The sparse labeling condition allowed the identification of these clusters of localizations. Localizations from many such clusters within ˜150 nm of the focal plane were aligned by their center of mass to generate the localization distribution reported in FIG. 1C. The localization precision determined from these distributions was ˜4 nm (SD) in the x-y directions and ˜8 nm (SD) in the z direction, respectively. The variation in localization precision across this region was small (within 15% of the average value). The localization precision determined from the sparsely labeled sample is a good representation for the densely labeled actin samples as the parameters relevant for the localization precision, such as the number of photons detected from individual molecules and the background fluorescence signal, were measured to be the same for both sparsely and densely labeled samples.

For STORM imaging of the densely labeled actin samples, relatively weak 405 nm activation intensities were used during the image acquisition time of ˜90,000 frames. This led to a typical linear localization density of 1 localization per 4 nm along individual actin filaments, which corresponds to a Nyquist Criterion based resolution of 8 nm, smaller than the 9 nm lateral and 19 nm axial resolutions determined above. As not all of the labeled molecules had been exhausted by the end of the 90,000 frames, the number of localizations could still be further increased by increasing the imaging time.

For the characterization of the widths of individual actin filaments, short (˜200 nm), straight segments of filaments in cells were chosen, along which no crossing or branching of filaments were observed. Analysis of 10 such segments yielded FWHM widths of 11+/−2 nm.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A microscopy system, comprising:
a sample region;
a first objective on a first side of the sample region;
a second objective on a second side of the sample region; and
a non-circularly-symmetric lens positioned in a first imaging path in optical communication with the first objective.

2. The microscopy system of claim 1, wherein the first objective and the second objective are collinearly positioned relative to each other.

3. (canceled)

4. The microscopy system of claim 1, wherein the non-circularly-symmetric lens is cylindrical lens.

5. The microscopy system of claim 1, wherein the non-circularly-symmetric lens is positioned in a second imaging path in optical communication with the second objective.

6. The microscopy system of claim 1, further comprising a second non-circularly-symmetric lens positioned in a second imaging path in optical communication with the second objective.

7. (canceled)

8. The microscopy system of claim 1, wherein the non-circularly-symmetric lens defines a focal region, wherein at least a portion of the sample does not overlap with the focal region.

9. The microscopy system of claim 1, wherein the sample region is substantially vertically positioned.

10. (canceled)

11. The microscopy system of claim 1, further comprising a detector in optical communication with the first objective via the first imaging path.

12-13. (canceled)

14. The microscopy system of claim 11, wherein at least some of the light from the sample region is not focused on the detector.

15. The microscopy system of claim 11, further comprising a second detector in optical communication with the second objective via a second imaging path.

16. The microscopy system of claim 1, further comprising an illumination path that intersects the sample region.

17. The microscopy system of claim 16, wherein the illumination path intersects the sample region with an incidence angle larger than about 55° relative to optical axis of the imaging system.

18. The microscopy system of claim 16, wherein the illumination path intersects the sample region with an incidence angle that is smaller than the critical angle of a glass-water interface.

19-29. (canceled)

30. A method, comprising:
acquiring a first plurality of images from a first side of a sample;
acquiring a second plurality of images from a second side of the sample; and
comparing the first and second plurality of images to determine positions of one or more entities in the sample by determining the shapes and/or intensities of the appearance of the entities present in the first and second plurality of images.

31. The method of claim 30, comprising acquiring the first plurality of images using a stochastic imaging technique.

32. (canceled)

33. The method of claim 31, wherein at least some of the entities are emissive entities, and wherein the stochastic imaging technique used to acquire the first plurality of images comprises:
applying incident light to the sample, wherein the incident light is able to cause a statistical subset of the plurality of emissive entities to emit light, and to subsequently deactivate the statistical subset of the plurality of emissive entities;
acquiring the light emitted by the statistical subset of the plurality of emissive entities to produce an image; and
repeating the above two acts one or more times, each time causing a statistically different subset of the emissive entities to emit light, thereby producing the first plurality of images.

34-49. (canceled)

50. The method of claim 30, comprising determining the ellipticity of the appearance of at least some of the entities in the first and second plurality of images.

51-53. (canceled)

54. The method of claim 30, comprising rejecting an entity due to non-anticorrelated changes between the appearance of the entity in the first plurality of images and the appearance of the entity in the second plurality of images.

55. The method of claim 30, comprising accepting an entity due to anticorrelated changes between the appearance of the entity in the first plurality of images and the appearance of the entity in the second plurality of images.

56-92. (canceled)

93. A method, comprising:
providing a sample comprising one or more entities;
acquiring a first plurality of images from a first side of the sample;
acquiring a second plurality of images from a second side of the sample;
accepting entities due to anticorrelated changes between the appearance of the entities in the first plurality of images and the appearance of the entities in the second plurality of images; and
assembling the accepted entities into a final data set or image.

94-106. (canceled)
